(19) United States
(12) Patent Application Publication
(10) Pub. No.: US 2022/0191008 A1
(43) Pub. Date: Jun. 16, 2022

(54) COMMUNICATION NETWORK-ANCHORED CRYPTOGRAPHIC KEY SHARING WITH THIRD-PARTY APPLICATION

(71) Applicant: Nokia Technologies Oy, Espoo (FI)

(72) Inventors: Suresh NAIR, Whippany, NJ (US); Anja JERICHOW, Grafing bei München (DE); Nagendra S. BYKAMPADI, Bangalore (IN)

(21) Appl. No.: 17/437,652

(22) PCT Filed: Mar. 4, 2020
(86) PCT No.: PCT/FI2020/050136

§ 371 Date: Sep. 9, 2021

(30) Foreign Application Priority Data
Mar. 12, 2019 (IN) 201941009648

(51) Int. Cl. H04L 9/08; H04L 67/141

(52) U.S. Cl. CPC H04L 9/085; H04L 9/0861; H04L 67/141

(57) ABSTRACT

In with a network exposure function of a communication network, a method comprises generating at least one application layer cryptographic key based on a request specific to given user equipment received from an application function, and sharing the application layer cryptographic key with the application function. The application layer cryptographic key is configured to enable the application function and the given user equipment to establish a secure communication session.

### FIELD

The field relates generally to communication systems, and more particularly, but not exclusively, to security management within such systems.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Fourth generation (4G) wireless mobile telecommunications technology, also known as Long Term Evolution (LTE) technology, was designed to provide high capacity mobile multimedia with high data rates particularly for human interaction. Next generation or fifth generation (5G) technology is intended to be used not only for human interaction, but also for machine type communications in so-called Internet of Things (IoT) networks.

While 5G networks are intended to enable massive IoT services (e.g., very large numbers of limited capacity devices) and mission-critical IoT services (e.g., requiring high reliability), improvements over legacy mobile communication services are supported in the form of enhanced mobile broadband (eMBB) services providing improved wireless Internet access for mobile devices.

In an example communication system, user equipment (5G UE in a 5G network or, more broadly, a UE) such as a mobile terminal (subscriber) communicates over an air interface with a base station or access point referred to as a gNB in a 5G network. The access point (e.g., gNB) is illustratively part of an access network of the communication system. For example, in a 5G network, the access network is referred to as a 5G System and is described in 5G Technical Specification (TS) 23.501, V15.4.0, entitled “Technical Specification Group Services and System Aspects; System Architecture for the 5G System,” the disclosure of which is incorporated by reference herein in its entirety. In general, the access point (e.g., gNB) provides access for the UE to a core network (CN), which then provides access for the UE to other UEs and/or a data network such as a packet data network (e.g., Internet).

TS 23.501 goes on to define a 5G Service-Based Architecture (SBA) which models services as network functions (NFs) that communicate with each other using representational state transfer application programming interfaces (Restful APIs).

Furthermore, 5G Technical Specification (TS) 33.501, V15.3.1, entitled “Technical Specification Group Services and System Aspects; Security Architecture and Procedures for the 5G System,” the disclosure of which is incorporated by reference herein in its entirety, further describes security management details associated with a 5G network.

Security management is an important consideration in any communication system. For example, security of communications between a UE and a third-party application program (“application”) is one example of security management. However, security of such communications presents several challenges in existing 5G approaches.

### SUMMARY

Illustrative embodiments provide improved techniques for security management in communication systems particularly with respect to third-party applications.

For example, in one illustrative embodiment in accordance with given user equipment, a method comprises generating at least one application layer cryptographic key when registering with a communication network. The at least one application layer cryptographic key corresponds to at least one application program. The method then sends a session establishment request to the application program, wherein the session establishment request comprises an identifier for the application layer cryptographic key.

In a further embodiment in accordance with a network function of a communication network, a method comprises receiving an application layer cryptographic key request from an application program. The application layer cryptographic key request comprises an identifier for given user equipment, an identifier for an application layer cryptographic key, and an identifier for an enterprise cryptographic key. The method sends an authentication information request with the identifier for the given user equipment to an authentication function, and then receives an authentication information response from the authentication function. The method then generates an application layer cryptographic key based at least in part on information in the authentication information response, and sends the application layer cryptographic key to the application program.

In another embodiment in accordance with a network exposure function of a communication network, a method comprises generating at least one application layer cryptographic key based on a request specific to given user equipment received from an application function, and sharing the application layer cryptographic key with the application function, wherein the application layer cryptographic key is configured to enable the application function and the given user equipment to establish a secure communication session.

Further illustrative embodiments are provided in the form of a non-transitory computer-readable storage medium having embodied therein executable program code that when executed by a processor causes the processor to perform the above steps. Still further illustrative embodiments comprise apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates a communication system with which one or more illustrative embodiments are implemented.

FIG. 2 illustrates processing architectures for key management participants, according to an illustrative embodiment.

FIG. 3 illustrates network functions of a communication system associated with secure communications between user equipment and a third-party application server, according to an illustrative embodiment.

FIG. 4 illustrates a key hierarchy wherein a network function of a communication network generates an enterprise key and then application-specific keys, according to an illustrative embodiment.

FIG. 5 illustrates a part of a cryptographic key management methodology between two participants in a communication network, according to an illustrative embodiment.

FIG. 6 illustrates a part of a cryptographic key management methodology between two participants in a communication network, according to an illustrative embodiment.

FIG. 7 illustrates a part of a cryptographic key management methodology between two participants in a communication network, according to an illustrative embodiment.

FIG. 8 illustrates a cryptographic key management methodology for communication network-anchored cryptographic key sharing with a third-party application, according to an illustrative embodiment.

### DETAILED DESCRIPTION

Embodiments will be illustrated herein in conjunction with example communication systems and associated techniques for providing security management (e.g., cryptographic key management) in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3GPP system elements such as a 3GPP next generation system (5G), the disclosed embodiments can be adapted in a straightforward manner to a variety of other types of communication systems.

In accordance with illustrative embodiments implemented in a 5G communication system environment, one or more 3GPP technical specifications (TS) and technical reports (TR) provide further explanation of user equipment and network elements/functions and/or operations that interact with one or more illustrative embodiments, e.g., the above-referenced 3GPP TS 23.501 and 3GPP TS 33.501. Other 3GPP TS/TR documents provide other conventional details that one of ordinary skill in the art will realize. However, while illustrative embodiments are well-suited for implementation associated with the above-mentioned 5G-related 3GPP standards, alternative embodiments are not necessarily intended to be limited to any particular standards.

Furthermore, illustrative embodiments will be explained herein in the context of the Open Systems Interconnection model (OSI model) which is a model that conceptually characterizes communication functions of a communication system such as, for example, a 5G network. The OSI model is typically conceptualized as a hierarchical stack with a given layer serving the layer above and being served by the layer below. Typically, the OSI model comprises seven layers with the top layer of the stack being the application layer (layer 7) followed by the presentation layer (layer 6), the session layer (layer 5), the transport layer (layer 4), the network layer (layer 3), the data link layer (layer 2), and the physical layer (layer 1). One of ordinary skill in the art will appreciate the functions and interworkings of the various layers and, thus, further details of each layer are not described herein. However, it is to be appreciated that while illustrative embodiments are well-suited for implementations that utilize an OSI model, alternative embodiments are not necessarily limited to any particular communication function model.

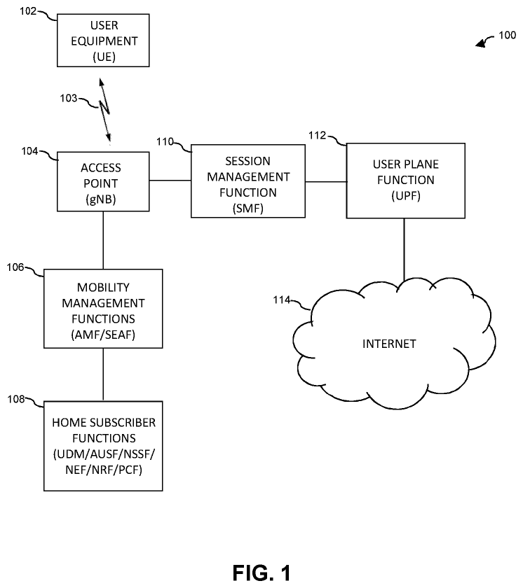

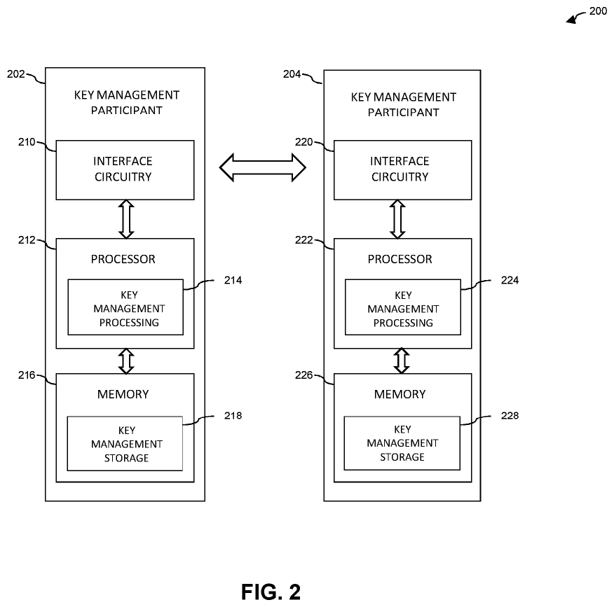

Illustrative embodiments are related to key management associated with the Service-Based Architecture (SBA) for 5G networks. Prior to describing such illustrative embodiments, a general description of main components of a 5G network will be described below in the context of FIGS. 1 and 2.

FIG. 1 shows a communication system 100 within which illustrative embodiments are implemented. It is to be understood that the elements shown in communication system 100 are intended to represent main functions provided within the system, e.g., UE access functions, mobility management functions, authentication functions, serving gateway functions, etc. As such, the blocks shown in FIG. 1 reference specific elements in 5G networks that provide these main functions. However, other network elements may be used in other embodiments to implement some or all of the main functions represented. Also, it is to be understood that not all functions of a 5G network are depicted in FIG. 1. Rather, functions that facilitate an explanation of illustrative embodiments are represented. Subsequent figures may depict some additional elements/functions.

Accordingly, as shown, communication system 100 comprises user equipment (UE) 102 that communicates via an air interface 103 with an access point (gNB) 104. The UE 102 in some embodiments is a mobile station, and such a mobile station may comprise, by way of example, a mobile telephone, a computer, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone or other cellular device. In one or more illustrative embodiments, user equipment refers to an IoT device. Such communication devices are also intended to encompass devices commonly referred to as access terminals.

In one embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores the permanent subscription identifier and its related key, which are used to identify and authenticate subscribers to access networks. The ME is the user-independent part of the UE and contains terminal equipment (TE) functions and various mobile termination (MT) functions.

Note that, in one example, the permanent subscription identifier is an International Mobile Subscriber Identity (IMSI) of a UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as a Subscription Concealed Identifier (SUCI).

The access point 104 is illustratively part of an access network of the communication system 100. Such an access network comprises, for example, a 5G System having a plurality of base stations and one or more associated radio network control functions. The base stations and radio network control functions in some embodiments are logically separate entities, but in some embodiments are implemented in the same physical network element, such as, for example, a base station router or cellular access point.

The access point 104 in this illustrative embodiment is operatively coupled to mobility management functions 106. In a 5G network, the mobility management function is implemented by an Access and Mobility Management Function (AMF). A Security Anchor Function (SEAF) in some embodiments is also implemented with the AMF connecting a UE with the mobility management function. A mobility management function, as used herein, is the element or function (i.e., entity) in the core network (CN) part of the communication system that manages or otherwise participates in, among other network operations, access and mobility (including authentication/authorization) operations with the UE (through the access point 104). The AMF is also referred to herein, more generally, as an access and mobility management entity.

The AMF 106 in this illustrative embodiment is operatively coupled to home subscriber functions 108, i.e., one or more functions that are resident in the home network of the subscriber. As shown, some of these functions include the Unified Data Management (UDM) function, as well as an Authentication Server Function (AUSF). The AUSF and UDM (separately or collectively) are also referred to herein, more generally, as an authentication entity. In addition, home subscriber functions include, but are not limited to, Network Slice Selection Function (NSSF), Network Exposure Function (NEF), Network Repository Function (NRF), and Policy Control Function (PCF).

Some of these functions will be further described herein in the context of key management with an Application Function (AF) that, in some illustrative embodiments, runs on an application server associated with a third party. By “third party” here, it is meant to refer to a party other than the subscriber of the UE or the operator of the core network. For example, in one or more illustrative embodiments, the third party is an enterprise (e.g., corporation, business, group, individual, or the like). In some embodiments, the subscriber of the UE is an employee of the enterprise (or otherwise affiliated) who maintains a mobile subscription with the operator of the core network or another mobile network. Note that a UE is typically subscribed to what is referred to as a Home Public Land Mobile Network (HPLMN) in which some or all of the home subscriber functions 108 reside. If the UE is roaming (not in the HPLMN), it is typically connected with a Visited Public Land Mobile Network (VPLMN) also referred to as a serving network. Some or all of the mobility management functions 106 may reside in the VPLMN, in which case, functions in the VPLMN communicate with functions in the HPLMN as needed. However, in a non-roaming scenario, mobility management functions 106 and home subscriber functions 108 can reside in the same communication network.

The access point 104 is also operatively coupled to a serving gateway function, i.e., Session Management Function (SMF) 110, which is operatively coupled to a User Plane Function (UPF) 112. UPF 112 is operatively coupled to a Packet Data Network, e.g., Internet 114. As is known in 5G and other communication networks, the user plane (UP) or data plane carries network user traffic while the control plane (CP) carries signaling traffic. SMF 110 supports functionalities relating to UP subscriber sessions, e.g., establishment, modification and release of PDU sessions. UPF 112 supports functionalities to facilitate UP operations, e.g., packet routing and forwarding, interconnection to the data network (e.g., 114 in FIG. 1), policy enforcement, and data buffering.

It is to be appreciated that FIG. 1 is a simplified illustration in that not all communication links and connections between network functions (NFs) and other system elements are illustrated in FIG. 1. One ordinarily skilled in the art given the various 3GPP TSs/TRs will appreciate the various links and connections not expressly shown or that may otherwise be generalized in FIG. 1.

Further typical operations and functions of certain network elements are not described herein in detail when they are not the focus of illustrative embodiments but can be found in appropriate 3GPP 5G documentation. It is to be appreciated that the particular arrangement of system elements in FIG. 1 is an example only, and other types and arrangements of additional or alternative elements can be used to implement a communication system in other embodiments. For example, in other embodiments, the system 100 comprises other elements/functions not expressly shown herein. Also, although only single elements/functions are shown in the FIG. 1 embodiment, this is for simplicity and clarity of illustration only. A given alternative embodiment may include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) comprise a series of network function (NF) sets (i.e., function chains) for each corresponding service type using network function virtualization (NFV) on a common physical infrastructure. The network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via gNB 104. NFs can also access services of other NFs.

Illustrative embodiments provide a key management methodology for communication network-anchored cryptographic key sharing with a third-party application. Note that when the term “key” is used alone, it is understood to refer to a cryptographic key.

FIG. 2 is a block diagram of processing architectures 200 of participants in a key management methodology in an illustrative embodiment. As will be further explained below, more than two participants are involved in key management according to illustrative embodiments, e.g., UE, AMF, AF, NEF, and UDM. As such, FIG. 2 illustrates processing architectures associated with any two of the participants that directly or indirectly communicate. Therefore, in illustrative embodiments, each participant in a key management methodology is understood to be configured with the processing architecture shown in FIG. 2.

As shown, a first key management participant 202 comprises a processor 212 coupled to a memory 216 and interface circuitry 210. The processor 212 of the first key management participant 202 includes a key management processing module 214 that may be implemented at least in part in the form of software executed by the processor. The processing module 214 performs key management described in conjunction with subsequent figures and otherwise herein. The memory 216 of the first key management participant 202 includes a key management storage module 218 that stores data generated or otherwise used during key management operations.

As further shown, a second key management participant 204 comprises a processor 222 coupled to a memory 226 and interface circuitry 220. The processor 222 of the second key management participant 204 includes a key management processing module 224 that may be implemented at least in part in the form of software executed by the processor 222. The processing module 224 performs key management described in conjunction with subsequent figures and otherwise herein. The memory 226 of the second key management participant 204 includes a key management storage module 228 that stores data generated or otherwise used during key management operations.

The processors 212 and 222 of the respective key management participants 202 and 204 may comprise, for example, microprocessors, application-specific integrated circuits (ASICs), field programmable gate arrays (FPGAs), digital signal processors (DSPs) or other types of processing devices or integrated circuits, as well as portions or combinations of such elements. Such integrated circuit devices, as well as portions or combinations thereof, are examples of “circuitry” as that term is used herein. A wide variety of other arrangements of hardware and associated software or firmware may be used in implementing the illustrative embodiments.

The memories 216 and 226 of the respective key management participants 202 and 204 may be used to store one or more software programs that are executed by the respective processors 212 and 222 to implement at least a portion of the functionality described herein. For example, key management operations and other functionality as described in conjunction with subsequent figures and otherwise herein may be implemented in a straightforward manner using software code executed by processors 212 and 222.

A given one of the memories 216 or 226 may therefore be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

The memory 216 or 226 may more particularly comprise, for example, an electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 of the respective key management participants 202 and 204 illustratively comprise transceivers or other communication hardware or firmware that allows the associated system elements to communicate with one another in the manner described herein.

It is apparent from FIG. 2 that first key management participant 202 is configured for communication with the second key management participant 204 and vice-versa via their respective interface circuitries 210 and 220. This communication involves the first key management participant 202 sending data to the second key management participant 204, and the second key management participant 204 sending data to the first key management participant 202. However, in alternative embodiments, other network elements or other components may be operatively coupled between, as well as to, the key management participants 202 and 204. The term “data” as used herein is intended to be construed broadly, so as to encompass any type of information that may be sent between key management participants including, but not limited to, messages, tokens, identifiers, keys, indicators, user data, control data, etc.

It is to be appreciated that the particular arrangement of components shown in FIG. 2 is an example only, and numerous alternative configurations are used in other embodiments. For example, any given network element/function can be configured to incorporate additional or alternative components and to support other communication protocols.

Given the above illustrative architectures, illustrative embodiments of key management methodologies for communication network-anchored cryptographic key sharing with a third-party application will be further described below. Prior to such descriptions, some main drawbacks that at least partially motivated development of illustrative embodiments will be described in the context of a 5G network.

Enterprises (third parties) host many applications that use a pre-shared cryptographic key to establish secure communication between the server (hosted in Enterprise premises) and the client (hosted on the end-user device (for e.g. an employee)). Typically, these keys are static in nature and configured manually on the server through out-of-band means.

In many cases, these enterprises also engage with a PLMN operator to provide voice/data services for its employees or to configure a dedicated enterprise network. But there is currently no standardized mechanism to bind the employee's subscription with the PLMN operator to the communication the employee establishes at the application layer.

Illustrative embodiments realize that it is beneficial to the enterprise, if there is a mechanism by which the pre-shared key for the communication session is bound to the end-user's subscription with the PLMN operator (e.g., HPLMN operator) and this key is shared by the operator to the enterprise over a standardized interface. This ensures 3GPP level security protection for the enterprise communication and also saves the enterprise the cost of maintaining a security infrastructure. Further, such a mechanism has many security advantages, for example:

a) Allows the PLMN operator to offer UE-specific cryptographic key as a service to the third-party applications;

b) Pre-shared keys are automatically refreshed (no longer static) every time the UE registers with the network; and

c) Saves the huge capital expenditure (CAPEX) and operational expenditure (OPEX) costs of the enterprise maintaining a separate security infrastructure.

Accordingly, illustrative embodiments provide a methodology for a PLMN operator to share one or more UE-specific cryptographic keys with third-party applications with which it has a contractual or other business agreement for such kind of a service.

In illustrative embodiments, the Network Exposure Function (NEF) is used as the security anchor. As will be further explained, the NEF exposes an additional (e.g., northbound) interface for third-party applications to obtain one or more UE-specific keys from the PLMN operator. The NEF interfaces with the UDM to obtain the necessary UE-specific Authentication Vector (AV), which is needed to generate a UE-specific Application Function (AF) key intended for the third-party application.

In accordance with one or more illustrative embodiments, key management for communication network-anchored cryptographic key sharing with a third-party application will be explained as comprising four parts. However, it is to be appreciated that portions of any given part may be performed in one or more of the other parts, and key management according to alternative embodiments may be considered as having less or more parts than the four illustratively delineated herein.

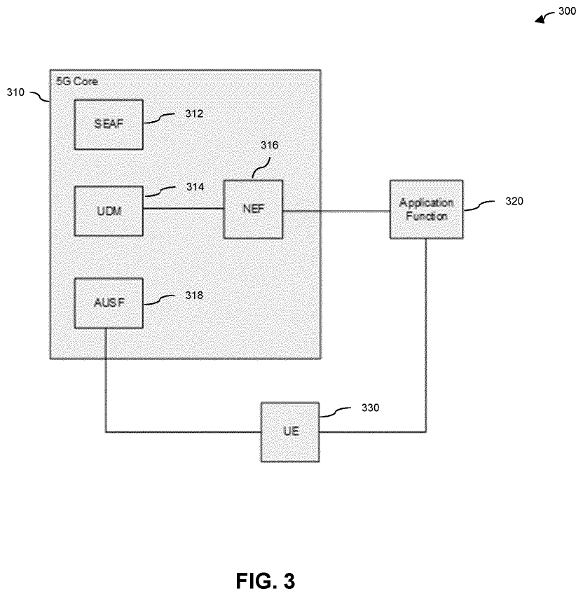

As will be further explained below in the context of FIGS. 3-8, the four parts comprise: (i) NEF as an anchor for generating a UE-specific application layer key and sharing the key to be used between the third-party application and the UE (Part 1); (ii) NEF interacts with UDM in 5G core to obtain AVs required to generate necessary application layer keys (Part 2); (iii) NEF exposes northbound application programming interfaces (APIs) for third-party applications to obtain keys and for other key management functions (Part 3); and (iv) UE generates application layer keys when it registers with the network (Part 4). Each of the illustrative parts will now be further described.

### Part 1: NEF as Security Anchor

NEF functionality is specified in the above-referenced TS 23.501 (e.g., clause 6.2.5).

In illustrative embodiments, the NEF is adapted as a security anchor that provides key management services to third-party application functions (AFs). The NEF is responsible for generating AF-specific key material to be used between the UE and the AF and maintaining an active UE context to be used for subsequent bootstrapping requests. The NEF and its functional environment are depicted in process 300 of FIG. 3 which shows how the NEF acts as a security anchor function for a third-party AF.

More particularly, FIG. 3 illustrates a 5G Core (CN) 310 with SEAF 312, UDM 314, NEF 316, and AUSF 318. NEF 316 is operatively coupled to UDM 314 and AF 320, while UE 330 is operatively coupled to AF 320 and AUSF 318.

NEF 316 interfaces with UDM 314 in 5G Core 310 to obtain the required inputs (such as Authentication Vector) for generating a UE-specific AF key (a key specific to UE 330 for AF 320). In another embodiment, UDM 314 generates an Enterprise key based on UE subscription data, which is then used by NEF 316 to generate an AF-specific cryptographic key using an AF identifier as one of the inputs.

Furthermore, NEF 316 provides a Service-Based Interface (SBI)-based northbound interface to AF 320.

### Part 2: NEF Interfaces With UDM to Obtain One or More AVs

In accordance with illustrative embodiments, a new interface is defined between the NEF and the UDM, which is used by the NEF to request one or more AVs from the UDM. Note that, in some embodiments, Nudm AuthenticationRequestInformation represents a new service offered by Nudm and used by NEF (but not limited to, rather potentially usable by another NF). Alternatively, in some embodiments, the new interface uses the same service of UDM as the AUSF when requesting AVs.

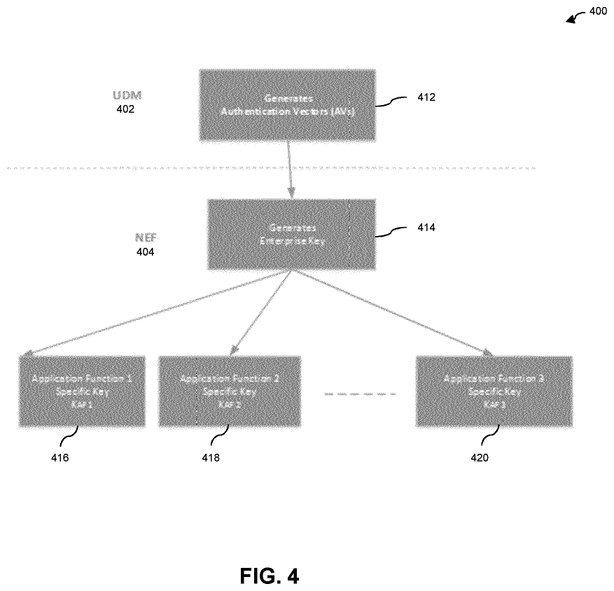

The NEF generates an Enterprise key from the AV and an AF-specific application layer session key from the Enterprise key. This key hierarchy 400 is illustrated in FIG. 4 with respect to UDM 402 and NEF 404.

More particularly, UDM 402 generates one or more AVs in step 412. NEF 404 receives the AVs and generates an Enterprise key in step 414 for a given enterprise. Then, from the Enterprise key, a set of AF-specific keys 416, 418 and 420 are generated for a respective set of application functions (AF1, AF2, AF3) associated with the given enterprise. It is to be understood that more or less AF-specific keys can be generated than what is illustratively depicted.

In another embodiment, the existing service based N6 interface (between AMF and UDM) is reused between NEF and UDM with additional APIs for key management service.

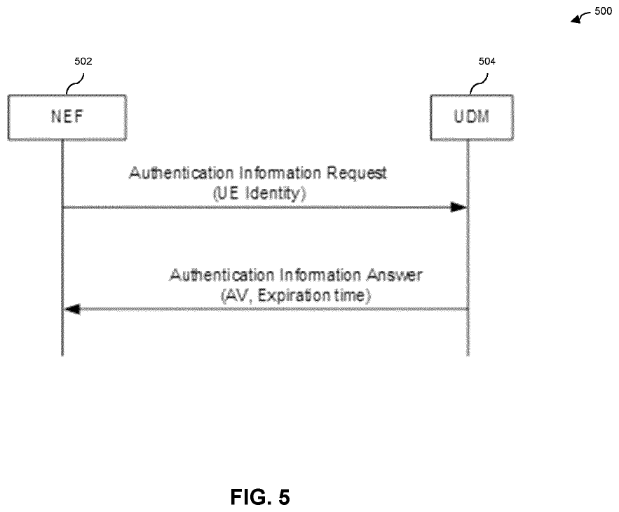

For example, as depicted in a message exchange 500 between NEF 502 and UDM 504 in FIG. 5, NEF 502 includes the identity of the UE in the Request API. UDM 504 returns a unique AV with the expiration time. How the NEF operates once it receives this response is further described below.

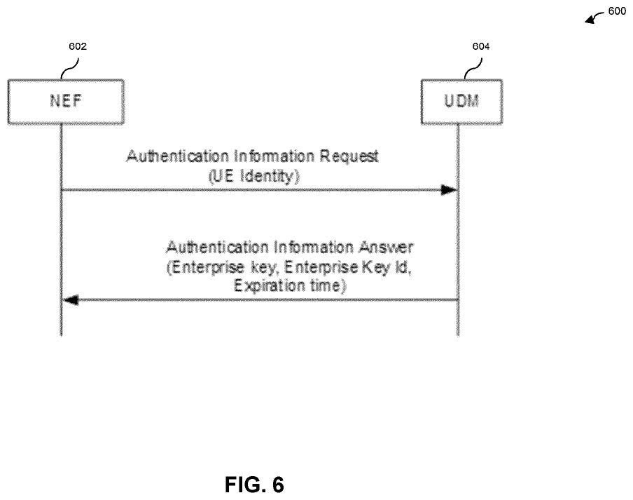

In yet another embodiment, key management responsibility is split between the UDM and the NEF. As depicted in a message exchange 600 between NEF 602 and UDM 604 in FIG. 6, based on an Authentication Information Request from NEF 602, UDM 604 generates a UE-specific Enterprise key and provides it to NEF 602 in the response (along with the Enterprise key identifier or Id). NEF 602 then generates an AF-specific key from the Enterprise Key and provides it to the application. This allows for a UE to connect to multiple AFs all connecting through the same NEF in the PLMN network by creating multiple AF-specific keys from the one Enterprise key.

### Part 3: NEF Exposes Northbound Interface to Third-Party Application

The NEF exposes a northbound API for third-party applications that intend to use PLMN's key management service to setup application layer security between the application and the UE.

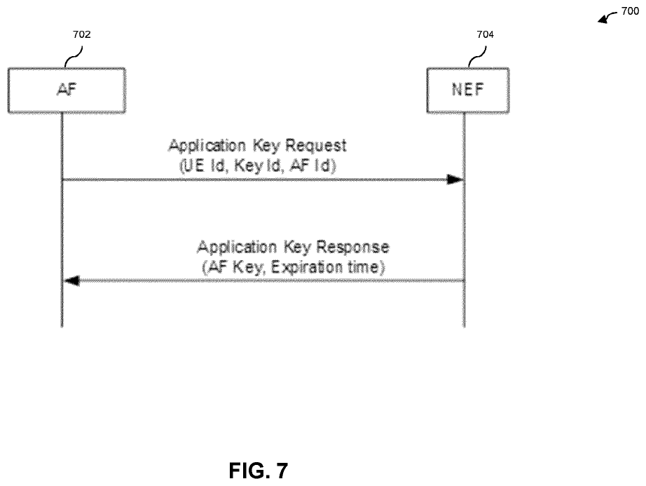

As depicted in a message exchange 700 between AF 702 and NEF 704 in FIG. 7, an Application Key Request API from AF 702 to NEF 704 includes UE Id, Enterprise Key Id, and AF Id. The UE (not expressly shown in FIG. 7) provides the first two parameters when it initiates a connection setup with the third-party application. The Key Id parameter identifies the UE-specific Enterprise key derived by the NEF or the UDM (depending on the embodiment).

### Part 4: UE Generates Additional Keys When it Registers With the Network

The UE registers with the network to get authorized to receive services from the network. For example, the UE performs the registration procedure as defined in 5G Technical Specification (TS) 23.502, V15.4.1, entitled “Technical Specification Group Services and System Aspects; Procedures for the 5G System, Stage 2,” the disclosure of which is incorporated by reference herein in its entirety, see, e.g., clause 4.2.2.2.2.

In accordance with illustrative embodiments, this registration procedure is enhanced as follows:

a) When the key management service is enabled in the UE, the UE generates AF-specific key(s) (AF K₁, . . . AF Kₙ) in addition to the Enterprise key. The AF-specific keys are used for application layer session establishment. The UE also generates an Enterprise key Id at the end of the registration step.

b) When the UE initiates a session with an AF, the UE includes the Enterprise key Id and the AF Id along with its own identifier.

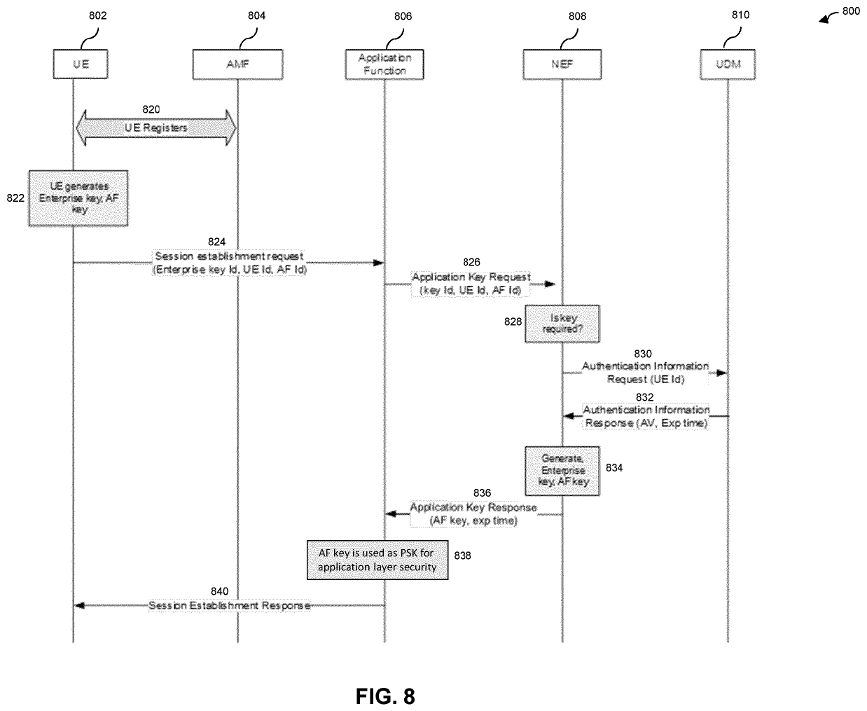

An end-to-end message flow 800 is shown in FIG. 8 according to an illustrative embodiment. The message flow 800 includes UE 802, AMF 804, AF 806, NEF 808, and UDM 810.

As shown, in step 820, UE 802 registers with AMF 804.

During registration, in step 822, UE 802 generates an Enterprise key and an AF key. More than one AF key can be generated depending on with how many AFs the UE is intending to communicate.

In step 824, UE 802 sends a Session Establishment Request with Enterprise key Id, UE id, and AF Id to AF 806.

AF 806, in step 826, sends an Application Key Request with Enterprise key Id, UE id, and AF Id to NEF 808.

In step 828, NEF 808 determines whether or not an AF key is required. NEF 808 verifies whether the enterprise and the application function has a business relationship for key management services, and verifies Enterprise key Id, UE id, and AF Id are entitled for key management services. In some alternative embodiments, NEF 808 contacts a data registry, which keeps the application functions listed. NEF 808 requests/checks what are the properties of using this AF and whether this mandates the need for an AF key. In other alternative embodiments, any AF that the UE may want to use is first exposed in NEF 808. The UE discovers and requests the AF, for some a key is needed, for some UE may already have the key (thus no new to be created), for others the application access is free. Thus, NEF 808 looks up this information and then uses the decision function in step 828 to decide whether an AF key is needed.

If so, in step 830, NEF 808 sends an Authentication Information Request with UE Id to UDM 810.

In step 832, UDM 810 sends an Authentication Information Response with the AV and expire time to NEF 808.

NEF 808, in step 834, generates an Enterprise key and an AF key.

In step 836, NEF 808 sends the AF key and expire time in an Application Key Response to AF 806.

In step 838, AF 806 uses the AF key as the Pre-Shared Key (PSK) for application layer security.

AF 806, in step 840, then sends a Session Establishment Response to UE 802.

The particular processing operations and other system functionality described in conjunction with the message flow diagrams of FIGS. 4-8 are presented by way of illustrative example only, and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

Advantageously, as described herein, illustrative embodiments provide solutions to support authentication and key management aspects for applications and 3GPP services based on 3GPP credentials in a 5G network, including the IoT use case. Such illustrative embodiments provide authentication and key management procedures to applications and 3GPP services in 5G scenarios which allow the UE to securely exchange data with an application server. More particularly, illustrative embodiments provide solutions for exposing a 3GPP based cryptographic key for the applications and the UE, which allow the UE to securely exchange data with a third-party application server.

It should therefore again be emphasized that the various embodiments described herein are presented by way of illustrative example only and should not be construed as limiting the scope of the claims. For example, alternative embodiments can utilize different communication system configurations, user equipment configurations, base station configurations, authentication and key agreement protocols, key pair provisioning and usage processes, messaging protocols and message formats than those described above in the context of the illustrative embodiments. These and numerous other alternative embodiments within the scope of the appended claims will be readily apparent to those skilled in the art.

1-24. (canceled)

25. An apparatus comprising:
at least one processor;
at least one memory including computer program code;
the at least one memory and the computer program code being configured to, with the at least one processor, cause the apparatus at least to:
generate at least one application layer cryptographic key when registering with a communication network, wherein the at least one application layer cryptographic key corresponds to at least one application program; and
send a session establishment request to the application program, wherein the session establishment request comprises an identifier for the application layer cryptographic key.

26. The apparatus of claim 25, wherein the at least one memory and the computer program code are further configured to, with the at least one processor, cause the apparatus at least to:
generate a cryptographic key associated with the entity that hosts the application program; and
send an identifier for the enterprise cryptographic key in the session establishment request with the identifier for the application layer cryptographic key.

27. The apparatus of claim 26, wherein the at least one memory and the computer program code are further configured to, with the at least one processor, cause the apparatus at least to send an identifier for the apparatus in the session establishment request with the identifier for the application layer cryptographic key and the identifier for the enterprise cryptographic key.

28. The apparatus of claim 25, wherein the at least one memory and the computer program code are further configured to, with the at least one processor, cause the apparatus at least to receive a session establishment response from the application program.

29. A method comprising:
in accordance with user equipment;
generating at least one application layer cryptographic key when registering with a communication network, wherein the at least one application layer cryptographic key corresponds to at least one application program; and
sending a session establishment request to the application program, wherein the session establishment request comprises an identifier for the application layer cryptographic key;
wherein the user equipment comprises a processor and memory configured to execute the above steps.

30. The method of claim 29, further comprising:
generating a cryptographic key associated with the entity that hosts the application program; and
sending an identifier for the enterprise cryptographic key in the session establishment request with the identifier for the application layer cryptographic key.

31. The method of claim 30, further comprising sending an identifier for the given user equipment in the session establishment request with the identifier for the application layer cryptographic key and the identifier for the enterprise cryptographic key.

32. The method of claim 29, further comprising receiving a session establishment response from the application program.

33. An article of manufacture comprising a non-transitory computer-readable storage medium having embodied therein executable program code that when executed by the processor associated with the user equipment causes the user equipment to perform the steps of claim 29.

34. An apparatus comprising:
at least one processor;
at least one memory including computer program code;
the at least one memory and the computer program code being configured to, with the at least one processor, cause the apparatus at least to:
receive an application layer cryptographic key request from an application program, wherein the application layer cryptographic key request comprises an identifier for user equipment, an identifier for an application layer cryptographic key, and an identifier for an enterprise cryptographic key;
send an authentication information request with the identifier for the user equipment to an authentication function;
receive an authentication information response from the authentication function;
generate an application layer cryptographic key based at least in part on information in the authentication information response; and
send the application layer cryptographic key to the application program.

35. The apparatus of claim 34, wherein the at least one memory and the computer program code are further configured to, with the at least one processor, cause the apparatus at least to execute as a network exposure function for performing the receive, send, receive, generate and send operations.

36. The apparatus of claim 34, wherein the authentication information response comprises an authentication vector corresponding to the user equipment and the application layer cryptographic key is generated based at least in part on the authentication vector.

37. The apparatus of claim 34, wherein the authentication information response comprises an enterprise cryptographic key and the application layer cryptographic key is generated based at least in part on the enterprise cryptographic key.

38. The apparatus of claim 34, wherein the application cryptographic key is sent to the application program with an expire time.

39. The apparatus of claim 34, wherein the at least one memory and the computer program code are further configured to, with the at least one processor, cause the apparatus at least to, upon receipt of the application layer cryptographic key request, determine whether an application layer cryptographic key is needed.
